(19) United States
(12) Patent Application Publication
(10) Pub. No.: US 2023/0018522 A1
(43) Pub. Date: Jan. 19, 2023

(54) PROCESS FOR REDUCING OXIDATION OF A FOODSTUFF AND RELATED COMPOSITIONS

(71) Applicant: DUPONT NUTRITION BIOSCIENCES APS, COPENHAGEN K (DK)

(72) Inventor: Ying J. Zhong, New Century, KS (US)

(21) Appl. No.: 17/777,094

(22) PCT Filed: Nov. 12, 2020
(86) PCT No.: PCT/US2020/060131

§ 371 Date: May 16, 2022

Related U.S. Application Data
(60) Provisional application No. 62/935,957, filed on Nov. 15, 2019.

(30) Foreign Application Priority Data
Dec. 16, 2019 (EP) 19216501.7

(51) Int. Cl. A23L 3/3472; A23B 4/20; A23B 7/154; A23B 9/26; A23C 3/08; A23L 27/60

(52) U.S. Cl. CPC A23L 3/3472; A23B 4/20; A23B 7/154; A23B 9/26; A23C 3/08; A23L 27/60

(57) ABSTRACT

This specification relates to a process for reducing oxidation of a foodstuff, an antioxidant composition for use in such a process, and a foodstuff wherein oxidation is reduced by such a process.

### CROSS REFERENCE TO RELATED PATENT APPLICATIONS

This specification claims priority to U.S. Provisional Patent Application No. 62/935,957 filed (Nov. 15, 2019) and European Patent Application No. EP19216501.7 (filed Dec. 16, 2019). The entire text of each of the above-referenced patent applications is incorporated by reference into this specification.

### FIELD

This specification relates to a process for reducing oxidation of a foodstuff, an antioxidant composition for use in such a process, and a foodstuff wherein oxidation is reduced by such a process.

### BACKGROUND

Antioxidants are widely used in food products susceptible to oxidative degeneration. An antioxidant is defined by the US Food and Drug Administration (21 CFR 170.3) as “a substance used to preserve food by retarding deterioration, rancidity, or discoloration due to oxidation”. There is an increasing need to develop economical, natural and effective food preservative systems to meet the public demand for convenient, natural, safe, healthy and good quality food products with a more reliable shelf life. To this end, spices or plant extracts can be used in food as antioxidants and to impart flavor. One advantage of such extracts is that they are perceived as natural ingredients when compared to, for example, ethylenediaminetetraacetic acid (“EDTA”), butyl hydroxyanisol (“BHA”) or butylated hydroxytoluene (“BHT”).

There is large number of known antioxidants based on naturally occurring plant materials. These materials have varying degrees of efficacy. For some of these materials, obtaining the antioxidant levels required to ensure preservation of foodstuffs may prove to uneconomical, or are above concentrations acceptable under various regulatory constraints. And, for some materials, the amount required to reach the desired antioxidant level can have an undesirable sensory impact.

The effectiveness of an antioxidant may be dependent on various factors, including, for example, its strength (i.e., its intrinsic antioxidant activity of the molecule), dosage and the application media. The environment can play an important role in the efficacy of an antioxidant, which may behave differently in bulk lipid and multiphase colloids. Under certain conditions, an antioxidant may act as a prooxidant; this is believed to be related to its localization/distribution and active concentration in the different phases (oil, water or interface) of the medium.

### SUMMARY

This specification provides a process to reduce oxidation of a foodstuff, an antioxidant composition useful in such a process, and a foodstuff in which oxidation has been reduced by such a process. This process generally can be useful for increasing the shelf-life and customer satisfaction of a foodstuff. It uses natural and relatively inexpensive ingredients in amounts that typically cause little or no discoloration to the foodstuff or a negative impact on flavor (and may, in some instances, add a pleasant or otherwise desired flavor).

Briefly, this specification discloses, in part, a process for reducing oxidation of a foodstuff. The process comprises contacting a foodstuff with a green tea [Camellia sinensis] extract and a citrus fiber. In some embodiments, the process comprises contacting a foodstuff with an antioxidant composition comprising a green tea [Camellia sinensis] extract and a citrus fiber.

This specification also discloses, in part, an antioxidant composition for use in reducing oxidation of a foodstuff, wherein the antioxidant composition comprises a green tea [Camellia sinensis] extract and a citrus fiber.

This specification also discloses, in part, a foodstuff. The foodstuff is protected from oxidation by a process as discussed in this specification. Here, protection of the foodstuff from oxidation means the onset of oxidation in the foodstuff is delayed and/or the rate of oxidation of the foodstuff is reduced or oxidation of the foodstuff is prevented.

This specification also discloses, in part, a preserved foodstuff composition. The preserved foodstuff composition comprises a foodstuff and an antoxidant composition. The antioxidant composition comprises a green tea [Camellia sinensis] extract and a citrus fiber.

This specification also discloses, in part, a kit. The kit comprises: (i) a green tea [Camellia sinensis] extract, (ii) a citrus fiber, and (iii) instructions for contacting the green tea [Camellia sinensis] extract with a foodstuff to reduce oxidation of the foodstuff.

Further benefits of the teachings of this specification will be apparent to one skilled in the art from reading this specification.

### BRIEF DESCRIPTION OF THE FIGURES

FIG. 1 shows peroxide values (PV) of the mayonnaise formulations tested in Example 1 after 1, 2 and 4 weeks of storage at 37° C.

FIG. 2 shows TBARS values of the mayonnaise formulations tested in Example 1 after 1, 2 and 4 weeks of storage at 37° C.

### DETAILED DESCRIPTION

This detailed description is intended to acquaint others skilled in the art with Applicant's invention, its principles, and its practical application so that others skilled in the art may adapt and apply Applicant's invention in its numerous forms, as they may be best suited to the requirements of a particular use. This detailed description and its specific examples, while indicating certain embodiments, are intended for purposes of illustration only. This specification, therefore, is not limited to the described embodiments, and may be variously modified.

This specification provides, in part, a combination of components for reducing oxidation in a foodstuff.

As used herein, the term “antioxidant” means a substance that reduces the amount of oxidation over a given period when compared to the oxidation that would have occurred in the absence of that substance. This reduction in oxidation can be manifested as a delay in the onset of oxidation and/or a reduction in the rate of oxidation or complete prevention of oxidation.

The term “flavorant” means a substance that alters or enhances the taste of a foodstuff when compared to the taste of the foodstuff in the absence of that substance.

### Green Tea Extract

One component of the antioxdant of this specification is green tea [Camellia sinensis] extract.

The term “extract” means any constituent of a plant that may be isolated from the plant or a part of the plant.

All term “green tea extract” (or “GTE”) in this specification means an extract from a plant of the species Camellia sinensis. The extract generally comprises an extract from a leaf and/or bud of Camellia sinensis or a constituent isolated from such a leaf and/or bud. In some embodiments, the GTE comprises an extract from a Camellia sinensis leaf. In some embodiments, the GTE comprises a constituent that has been extracted from a Camellia sinensis leaf.

Green tea extracts are generally soluble in water and insoluble in oil. Numerous in vitro and in vivo studies have suggested the beneficial health properties of green tea (Camellia sinensis) and tea polyphenols, including antioxidant and antimicrobial activity. See, e.g., Kubo, I., et al., “Antimicrobial activity of green tea flavor components and their combination effects”, Journal of Agricultural and Food Chemistry, vol. 40, pp. 245-48 (1992). Catechins are a class of flavonoids, and a major component of green tea. Catechins and their gallates are reported to have antimicrobial and antioxidant activity, with the substances having an epi-configuration being particularly active. See, e.g., Yam, T. S., et al., “Microbiological activity of whole and fractionated crude extracts of tea (Camellia sinensis), and of tea components”. FEMS Microbiol. Lett., vol. 152, pp. 169-74 (1997); Kajiya, K, et. al., “Steric effects on interaction of tea catechins with lipid bilayers”, Bioscience, Biotechnology and Biochemistry, vol. 65, pp. 2638-43 (2001). In general, the antioxidant activity in a GTE is primarily due to four catechins, with the main components being epigallocatechin gallate (“EGCg”) and epicatechin gallate (“ECg”).

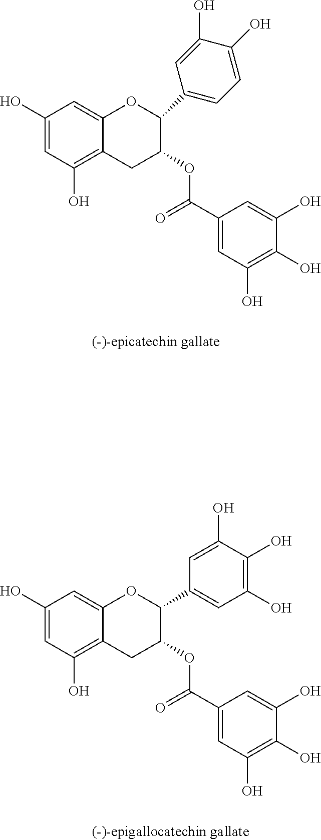 [SMILES: O=C(O[C@@H]1Cc2c(O)cc(O)cc2O[C@@H]1c1ccc(O)c(O)c1)c1cc(O)c(O)c(O)c1 ; O=C(O[C@@H]1Cc2c(O)cc(O)cc2O[C@@H]1c1cc(O)c(O)c(O)c1)c1cc(O)c(O)c(O)c1]

In some embodiments, the GTE comprises a tea polyphenol. In some embodiments, the GTE comprises a catechin. In some embodiments, the GTE comprises:

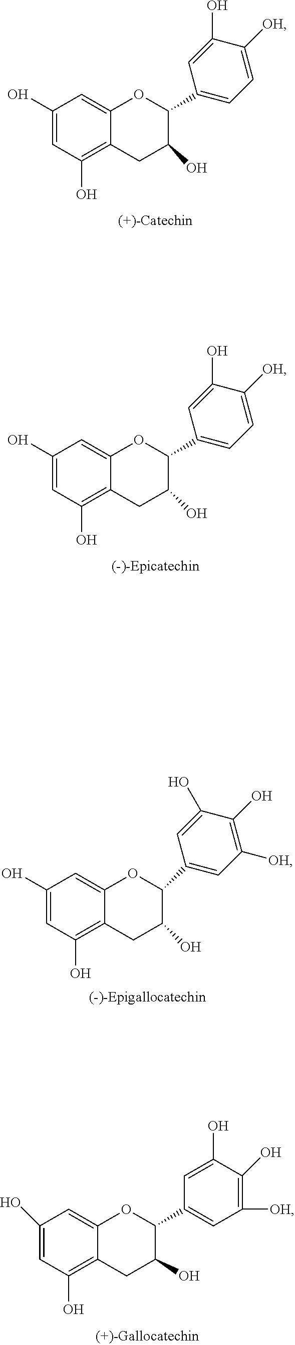 [SMILES: Oc1cc(O)c2c(c1)O[C@H](c1ccc(O)c(O)c1)[C@@H](O)C2 ; Oc1cc(O)c2c(c1)O[C@H](c1ccc(O)c(O)c1)[C@H](O)C2 ; Oc1cc(O)c2c(c1)O[C@H](c1cc(O)c(O)c(O)c1)[C@H](O)C2 ; Oc1cc(O)c2c(c1)O[C@H](c1cc(O)c(O)c(O)c1)[C@@H](O)C2]

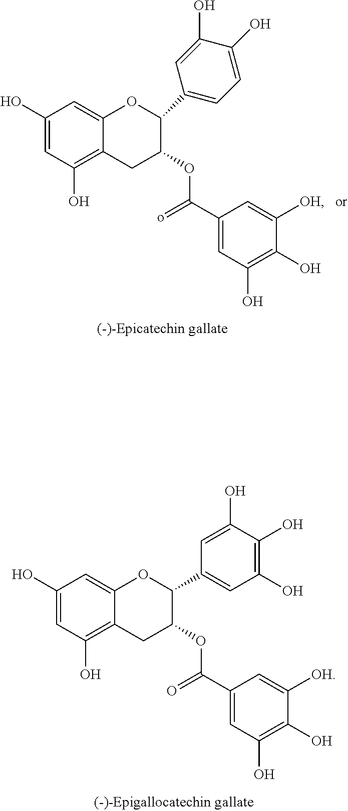

These compounds are sometimes referred to in this specification as “green tea catechins” or “green tea extract catechins.” A GTE may, for example, comprise these six catechins in a combined concentration of approximately 75% (by weight), based on the GTE.

In some embodiments, the GTE comprises:

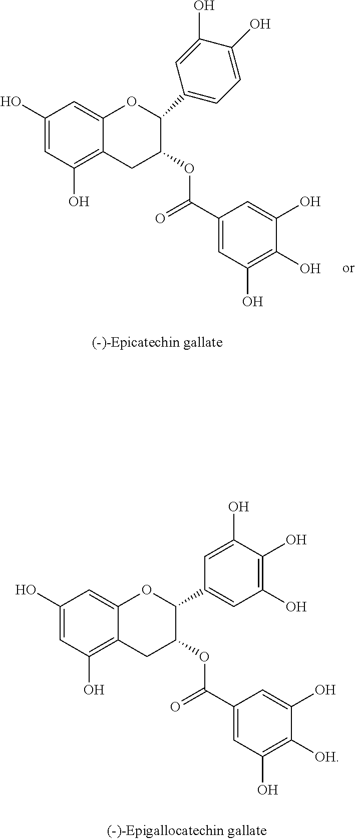 [SMILES: O=C(O[C@@H]1Cc2c(O)cc(O)cc2O[C@@H]1c1ccc(O)c(O)c1)c1cc(O)c(O)c(O)c1 ; O=C(O[C@@H]1Cc2c(O)cc(O)cc2O[C@@H]1c1cc(O)c(O)c(O)c1)c1cc(O)c(O)c(O)c1]

In general, the amount of GTE present in an antioxidant used in a process of this specification is an amount that provides a desired antioxidant effect on the foodstuff, taking into account the amount of the citrus fiber used as well. In some embodiments, the amount of GTE used does not negatively impact the flavor of the foodstuff.

The amount of GTE used in a process or included in an antioxidant compostion of this specification typically depends on the concentration of catechins in the GTE. To illustrate, the GTE concentrations discussed in the following paragraphs for an antioxidant composition of this specification are generally based on a GTE containing 80% (by weight) catechins. Using the teachings of this specification, a skilled artisan can modify these illustrative GTE concentrations to account for a GTE having a different catechin concentration.

In some embodiments, the antioxidant composition comprises the GTE at a concentration of at least 0.1% (by weight), based on the total weight of the antioxidant composition. In some embodiments, the antioxidant composition comprises the GTE at a concentration of at least 0.2% (by weight), based on the total weight of the antioxidant composition. In some embodiments, the antioxidant composition comprises the GTE at a concentration of at least 0.5% (by weight), based on the total weight of the antioxidant composition. In some embodiments, the antioxidant composition comprises the GTE at a concentration of at least 1% (by weight), based on the total weight of the antioxidant composition. In some embodiments, the antioxidant composition comprises the GTE at a concentration of at least 2% (by weight), based on the total weight of the antioxidant composition. In some embodiments, the antioxidant composition comprises the GTE at a concentration of at least 3% (by weight), based on the total weight of the antioxidant composition. In some embodiments, the antioxidant composition comprises the GTE at a concentration of at least 4% (by weight), based on the total weight of the antioxidant composition. In some embodiments, the antioxidant composition comprises the GTE at a concentration of at least 5% (by weight), based on the total weight of the antioxidant composition. In some embodiments, the antioxidant composition comprises the GTE at a concentration of at least 10% (by weight), based on the total weight of the antioxidant composition.

In some embodiments, the antioxidant composition comprises the GTE at a concentration of no greater than 40% (by weight), based on the total weight of the antioxidant composition. In some embodiments, the antioxidant composition comprises the GTE at a concentration of no greater than 35% (by weight), based on the total weight of the antioxidant composition. In some embodiments, the antioxidant composition comprises the GTE at a concentration of no greater than 30% (by weight), based on the total weight of the antioxidant composition. In some embodiments, the antioxidant composition comprises the GTE at a concentration of no greater than 25% (by weight), based on the total weight of the antioxidant composition. In some embodiments, the antioxidant composition comprises the GTE at a concentration of no greater than 20% (by weight), based on the total weight of the antioxidant composition. In some embodiments, the antioxidant composition comprises the GTE at a concentration of no greater than 15% (by weight), based on the total weight of the antioxidant composition. In some embodiments, the antioxidant composition comprises the GTE at a concentration of no greater than 12% (by weight), based on the total weight of the antioxidant composition. In some embodiments, the antioxidant composition comprises the GTE at a concentration of no greater than 11% (by weight), based on the total weight of the antioxidant composition. In some embodiments, the antioxidant composition comprises the GTE at a concentration of no greater than 10% (by weight), based on the total weight of the antioxidant composition. In some embodiments, the antioxidant composition comprises the GTE at a concentration of no greater than 8% (by weight), based on the total weight of the antioxidant composition. In some embodiments, the antioxidant composition comprises the GTE at a concentration of no greater than 6% (by weight), based on the total weight of the antioxidant composition. In some embodiments, the antioxidant composition comprises the GTE at a concentration of no greater than 5% (by weight), based on the total weight of the antioxidant composition.

In some embodiments, the antioxidant composition comprises the GTE at a concentration of from 0.1 to 20% (by weight), based on the total weight of the antioxidant composition. In some embodiments, the antioxidant composition comprises the GTE at a concentration of from 0.2 to 20% (by weight), based on the total weight of the antioxidant composition. In some embodiments, the antioxidant composition comprises the GTE at a concentration of from 0.5 to 20% (by weight), based on the total weight of the antioxidant composition. In some embodiments, the antioxidant composition comprises the GTE at a concentration of from 1 to 20% (by weight), based on the total weight of the antioxidant composition. In some embodiments, the antioxidant composition comprises the GTE at a concentration of from 2 to 20% (by weight), based on the total weight of the antioxidant composition. In some embodiments, the antioxidant composition comprises the GTE at a concentration of from 3 to 20% (by weight), based on the total weight of the antioxidant composition. In some embodiments, the antioxidant composition comprises the GTE at a concentration of from 4 to 20% (by weight), based on the total weight of the antioxidant composition. In some embodiments, the antioxidant composition comprises the GTE at a concentration of from 5 to 20% (by weight), based on the total weight of the antioxidant composition. In some embodiments, the antioxidant composition comprises the GTE at a concentration of from 7 to 20% (by weight), based on the total weight of the antioxidant composition. In some embodiments, the antioxidant composition comprises the GTE at a concentration of from 10 to 20% (by weight), based on the total weight of the antioxidant composition.

In some embodiments, the antioxidant composition comprises the GTE at a concentration of from 0.1 to 15% (by weight), based on the total weight of the antioxidant composition. In some embodiments, the antioxidant composition comprises the GTE at a concentration of from 0.2 to 15% (by weight), based on the total weight of the antioxidant composition. In some embodiments, the antioxidant composition comprises the GTE at a concentration of from 0.5 to 15% (by weight), based on the total weight of the antioxidant composition. In some embodiments, the antioxidant composition comprises the GTE at a concentration of from 1 to 15% (by weight), based on the total weight of the antioxidant composition. In some embodiments, the antioxidant composition comprises the GTE at a concentration of from 2 to 15% (by weight), based on the total weight of the antioxidant composition. In some embodiments, the antioxidant composition comprises the GTE at a concentration of from 3 to 15% (by weight), based on the total weight of the antioxidant composition. In some embodiments, the antioxidant composition comprises the GTE at a concentration of from 4 to 15% (by weight), based on the total weight of the antioxidant composition. In some embodiments, the antioxidant composition comprises the GTE at a concentration of from 5 to 15% (by weight), based on the total weight of the antioxidant composition. In some embodiments, the antioxidant composition comprises the GTE at a concentration of from 7 to 15% (by weight), based on the total weight of the antioxidant composition. In some embodiments, the antioxidant composition comprises the GTE at a concentration of from 10 to 15% (by weight), based on the total weight of the antioxidant composition.

In some embodiments, the antioxidant composition comprises the GTE at a concentration of from 0.1 to 18% (by weight), based on the total weight of the antioxidant composition. In some embodiments, the antioxidant composition comprises the GTE at a concentration of from 0.1 to 16% (by weight), based on the total weight of the antioxidant composition. In some embodiments, the antioxidant composition comprises the GTE at a concentration of from 0.1 to 14% (by weight), based on the total weight of the antioxidant composition. In some embodiments, the antioxidant composition comprises the GTE at a concentration of from 0.1 to 12% (by weight), based on the total weight of the antioxidant composition. In some embodiments, the antioxidant composition comprises the GTE at a concentration of from 0.1 to 10% (by weight), based on the total weight of the antioxidant composition. In some embodiments, the antioxidant composition comprises the GTE at a concentration of from 0.1 to 8% (by weight), based on the total weight of the antioxidant composition. In some embodiments, the antioxidant composition comprises the GTE at a concentration of from 0.1 to 6% (by weight), based on the total weight of the antioxidant composition. In some embodiments, the antioxidant composition comprises the GTE at a concentration of from 0.1 to 5% (by weight), based on the total weight of the antioxidant composition.

In some embodiments, the antioxidant composition comprises the GTE at a concentration of from 1 to 18% (by weight), based on the total weight of the antioxidant composition. In some embodiments, the antioxidant composition comprises the GTE at a concentration of from 1 to 16% (by weight), based on the total weight of the antioxidant composition. In some embodiments, the antioxidant composition comprises the GTE at a concentration of from 1 to 14% (by weight), based on the total weight of the antioxidant composition. In some embodiments, the antioxidant composition comprises the GTE at a concentration of from 1 to 12% (by weight), based on the total weight of the antioxidant composition. In some embodiments, the antioxidant composition comprises the GTE at a concentration of from 1 to 10% (by weight), based on the total weight of the antioxidant composition. In some embodiments, the antioxidant composition comprises the GTE at a concentration of from 1 to 8% (by weight), based on the total weight of the antioxidant composition. In some embodiments, the antioxidant composition comprises the GTE at a concentration of from 1 to 6% (by weight), based on the total weight of the antioxidant composition. In some embodiments, the antioxidant composition comprises the GTE at a concentration of from 1 to 5% (by weight), based on the total weight of the antioxidant composition.

In some embodiments, the antioxidant composition comprises the GTE at a concentration of from 0.1 to 10% (by weight), based on the total weight of the antioxidant composition. In some embodiments, the antioxidant composition comprises the GTE at a concentration of from 0.2 to 10% (by weight), based on the total weight of the antioxidant composition. In some embodiments, the antioxidant composition comprises the GTE at a concentration of from 0.5 to 10% (by weight), based on the total weight of the antioxidant composition. In some embodiments, the antioxidant composition comprises the GTE at a concentration of from 1 to 10% (by weight), based on the total weight of the antioxidant composition. In some embodiments, the antioxidant composition comprises the GTE at a concentration of from 2 to 10% (by weight), based on the total weight of the antioxidant composition. In some embodiments, the antioxidant composition comprises the GTE at a concentration of from 3 to 10% (by weight), based on the total weight of the antioxidant composition. In some embodiments, the antioxidant composition comprises the GTE at a concentration of from 4 to 10% (by weight), based on the total weight of the antioxidant composition. In some embodiments, the antioxidant composition comprises the GTE at a concentration of from 5 to 10% (by weight), based on the total weight of the antioxidant composition. In some embodiments, the antioxidant composition comprises the GTE at a concentration of from 6 to 10% (by weight), based on the total weight of the antioxidant composition. In some embodiments, the antioxidant composition comprises the GTE at a concentration of from 7 to 10% (by weight), based on the total weight of the antioxidant composition. In some embodiments, the antioxidant composition comprises the GTE at a concentration of from 8 to 10% (by weight), based on the total weight of the antioxidant composition.

In some embodiments, the antioxidant composition comprises the GTE at a concentration of from 0.1 to 12% (by weight), based on the total weight of the antioxidant composition. In some embodiments, the antioxidant composition comprises the GTE at a concentration of from 0.2 to 12% (by weight), based on the total weight of the antioxidant composition. In some embodiments, the antioxidant composition comprises the GTE at a concentration of from 0.5 to 12% (by weight), based on the total weight of the antioxidant composition. In some embodiments, the antioxidant composition comprises the GTE at a concentration of from 1 to 12% (by weight), based on the total weight of the antioxidant composition. In some embodiments, the antioxidant composition comprises the GTE at a concentration of from 2 to 12% (by weight), based on the total weight of the antioxidant composition. In some embodiments, the antioxidant composition comprises the GTE at a concentration of from 3 to 12% (by weight), based on the total weight of the antioxidant composition. In some embodiments, the antioxidant composition comprises the GTE at a concentration of from 4 to 12% (by weight), based on the total weight of the antioxidant composition. In some embodiments, the antioxidant composition comprises the GTE at a concentration of from 5 to 12% (by weight), based on the total weight of the antioxidant composition. In some embodiments, the antioxidant composition comprises the GTE at a concentration of from 6 to 12% (by weight), based on the total weight of the antioxidant composition. In some embodiments, the antioxidant composition comprises the GTE at a concentration of from 7 to 12% (by weight), based on the total weight of the antioxidant composition. In some embodiments, the antioxidant composition comprises the GTE at a concentration of from 8 to 12% (by weight), based on the total weight of the antioxidant composition. In some embodiments, the antioxidant composition comprises the GTE at a concentration of from 9 to 12% (by weight), based on the total weight of the antioxidant composition.

In some embodiments, the antioxidant composition comprises the GTE at a concentration of from 4 to 18% (by weight), based on the total weight of the antioxidant composition. In some embodiments, the antioxidant composition comprises the GTE at a concentration of from 4 to 16% (by weight), based on the total weight of the antioxidant composition. In some embodiments, the antioxidant composition comprises the GTE at a concentration of from 4 to 14% (by weight), based on the total weight of the antioxidant composition. In some embodiments, the antioxidant composition comprises the GTE at a concentration of from 4 to 12% (by weight), based on the total weight of the antioxidant composition. In some embodiments, the antioxidant composition comprises the GTE at a concentration of from 4 to 10% (by weight), based on the total weight of the antioxidant composition. In some embodiments, the antioxidant composition comprises the GTE at a concentration of from 4 to 8% (by weight), based on the total weight of the antioxidant composition. In some embodiments, the antioxidant composition comprises the GTE at a concentration of from 4 to 6% (by weight), based on the total weight of the antioxidant composition. In some embodiments, the antioxidant composition comprises the GTE at a concentration of from 4 to 5% (by weight), based on the total weight of the antioxidant composition.

In some embodiments, the antioxidant composition comprises the GTE at a concentration of from 1.5 to 7% (by weight), based on the total weight of the antioxidant composition. In some embodiments, the antioxidant composition comprises the GTE at a concentration of from 2 to 7% (by weight), based on the total weight of the antioxidant composition. In some embodiments, the antioxidant composition comprises the GTE at a concentration of from 4 to 7% (by weight), based on the total weight of the antioxidant composition.

In some embodiments, the antioxidant composition comprises the GTE at a concentration of from 0.1 to 5% (by weight), based on the total weight of the antioxidant composition. In some embodiments, the antioxidant composition comprises the GTE at a concentration of from 0.2 to 5% (by weight), based on the total weight of the antioxidant composition. In some embodiments, the antioxidant composition comprises the GTE at a concentration of from 0.5 to 5% (by weight), based on the total weight of the antioxidant composition. In some embodiments, the antioxidant composition comprises the GTE at a concentration of from 1 to 5% (by weight), based on the total weight of the antioxidant composition. In some embodiments, the antioxidant composition comprises the GTE at a concentration of from 2 to 5% (by weight), based on the total weight of the antioxidant composition. In some embodiments, the antioxidant composition comprises the GTE at a concentration of from 3 to 5% (by weight), based on the total weight of the antioxidant composition. In some embodiments, the antioxidant composition comprises the GTE at a concentration of from 4 to 5% (by weight), based on the total weight of the antioxidant composition.

In some embodiments, the antioxidant composition comprises one or more green tea extract catechins selected from:

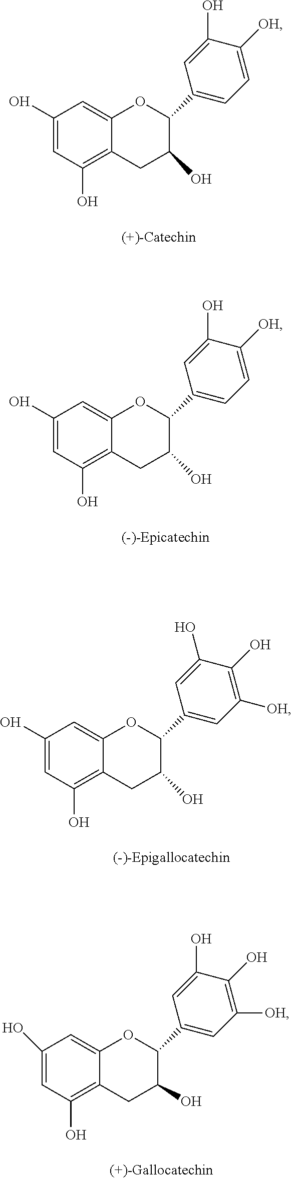 [SMILES: Oc1cc(O)c2c(c1)O[C@H](c1ccc(O)c(O)c1)[C@@H](O)C2 ; Oc1cc(O)c2c(c1)O[C@H](c1ccc(O)c(O)c1)[C@H](O)C2 ; Oc1cc(O)c2c(c1)O[C@H](c1cc(O)c(O)c(O)c1)[C@H](O)C2 ; Oc1cc(O)c2c(c1)O[C@H](c1cc(O)c(O)c(O)c1)[C@@H](O)C2]

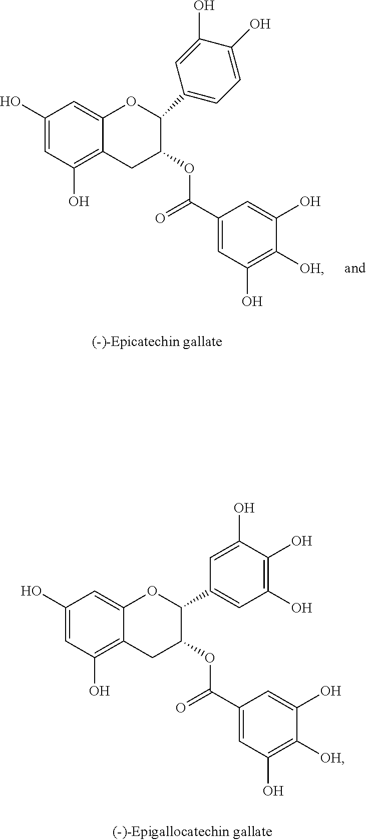 [SMILES: O=C(O[C@@H]1Cc2c(O)cc(O)cc2O[C@@H]1c1ccc(O)c(O)c1)c1cc(O)c(O)c(O)c1 ; O=C(O[C@@H]1Cc2c(O)cc(O)cc2O[C@@H]1c1cc(O)c(O)c(O)c1)c1cc(O)c(O)c(O)c1]

in a total concentration of at least 0.1% (by weight), based on the total weight of the antioxidant composition.

In some embodiments, such green tea catechins are present in the antioxidant composition in a total concentration of at least 0.2% (by weight), based on the total weight of the antioxidant composition. In some embodiments, such green tea catechins are present in the antioxidant composition in a total concentration of at least 0.3% (by weight), based on the total weight of the antioxidant composition. In some embodiments, such green tea catechins are present in the antioxidant composition in a total concentration of at least 0.4% (by weight), based on the total weight of the antioxidant composition. In some embodiments, such green tea catechins are present in the antioxidant composition in a total concentration of at least 0.5% (by weight), based on the total weight of the antioxidant composition. In some embodiments, such green tea catechins are present in the antioxidant composition in a total concentration of at least 1.0% (by weight), based on the total weight of the antioxidant composition. In some embodiments, such green tea catechins are present in the antioxidant composition in a total concentration of at least 1.5% (by weight), based on the total weight of the antioxidant composition. In some embodiments, such green tea catechins are present in the antioxidant composition in a total concentration of at least 2.0% (by weight), based on the total weight of the antioxidant composition.

In some embodiments, such green tea catechins are present in the antioxidant composition in a total concentration of no greater than 20% (by weight), based on the total weight of the antioxidant composition. In some embodiments, such green tea catechins are present in the antioxidant composition in a total concentration of no greater than 15% (by weight), based on the total weight of the antioxidant composition. In some embodiments, such green tea catechins are present in the antioxidant composition in a total concentration of no greater than 10% (by weight), based on the total weight of the antioxidant composition.

In some embodiments, such green tea catechins are present in the antioxidant composition in a total concentration of from 0.1 to 20% (by weight), based on the total weight of the antioxidant composition. In some embodiments, such green tea catechins are present in the antioxidant composition in a total concentration of from 0.1 to 15% (by weight), based on the total weight of the antioxidant composition. In some embodiments, such green tea catechins are present in the antioxidant composition in a total concentration of from 0.1 to 10% (by weight), based on the total weight of the antioxidant composition. In some embodiments, such green tea catechins are present in the antioxidant composition in a total concentration of from 0.2 to 10% (by weight), based on the total weight of the antioxidant composition. In some embodiments, such green tea catechins are present in the antioxidant composition in a total concentration of from 0.5 to 10% (by weight), based on the total weight of the antioxidant composition. In some embodiments, such green tea catechins are present in the antioxidant composition in a total concentration of from 1 to 10% (by weight), based on the total weight of the antioxidant composition. In some embodiments, such green tea catechins are present in the antioxidant composition in a total concentration of from 1.5 to 7% (by weight), based on the total weight of the antioxidant composition. In some embodiments, such green tea catechins are present in the antioxidant composition in a total concentration of from 2 to 7% (by weight), based on the total weight of the antioxidant composition. In some embodiments, such green tea catechins are present in the antioxidant composition in a total concentration of from 4 to 7% (by weight), based on the total weight of the antioxidant composition.

In some embodiments, the GTE is a dried solid (e.g., powder, granule, etc.). In some embodiments, the GTE is in the form of a liquid (e.g., in an aqueous medium). In some embodiments, the GTE is in the form of a suspension.

### Citrus Fiber

Another component of the antioxidant of this specification is a citrus fiber (“CF”). A CF is a fiber obtained from a fruit of the citrus family.

The citrus family is a large and diverse family of flowering plants. Citrus fruit is considered to be a berry characterized by a leathery peel and a fleshy interior containing multiple sections filled with juice-filled sacs. Common varieties of the citrus fruit include oranges, clementines, kumquats, tangerines, tangelos, satsumas, mandarins, grapefruits, citrons, pomelos, lemons, and limes. The citrus fruit may be early-season, mid-season or late-season citrus fruit.

In some embodiments, the antioxidant comprises CF extracted from an orange, tangerine, lime, lemon or grapefruit.

In some embodiments, the antioxidant comprises CF extracted from an orange. In some embodiments, the CF in the antioxidant consists of orange fiber.

In some embodiments, the antioxidant comprises CF extracted from a tangerine. In some embodiments, the CF in the antioxidant consists of tangerine fiber.

In some embodiments, the antioxidant comprises CF extracted from a lemon. In some embodiments, the CF in the antioxidant consists of lemon fiber.

In some embodiments, the antioxidant comprises CF extracted from a lime. In some embodiments, the CF in the antioxidant consists of lime fiber.

In some embodiments, the antioxidant comprises CF extracted from a grapefruit. In some embodiments, the CF in the antioxidant consists of grapefuit fiber.

In some embodiments, the CF in the antioxidant comprises fibers from two different types of citrus fruits. In some embodiments, the CF in the antioxidant consists of fibers from two different types of citrus fruits. In some embodiments, the CF in the antioxidant comprises fibers from three different types of citrus fruits. In some embodiments, the CF in the antioxidant consists of fibers from three different types of citrus fruits. In some embodiments, the CF in the antioxidant comprises fibers from more than three different types of citrus fruits.

In general, a CF is extracted from a source of the CF. In some embodiments, for example, a citrus fruit (e.g., an orange) is picked and sent to a citrus processing center where it is squeezed to make orange juice. The remaining portion of the citrus fruit, which may include juice vesicles, rag (membrane and core) and peel, is then sent to a manufacturing facility to extract CF. Many processes for conducting such an extraction are known in the art.

In some embodiments, the CF is extracted from juice vesicles, rag, and/or peel of a citrus fruit. In some embodiments, the CF is extracted from juice vesicles, rag or peel of a citrus fruit. In some embodiments, the CF is extracted from juice vesicles, rag, and peel of a citrus fruit.

In some embodiments, the CF is extracted from citrus vesicles. The term “citrus vesicle” refers to the cellulosic material contained in the inner, juice-containing portion of citrus fruit. Citrus vesicles are sometimes also referred to in the art as coarse pulp, floaters, citrus cells, floating pulp or pulp.

In some embodiments, the CF is additionally or alternatively extracted from the peel of the fruit.

In some embodiments, the CF is provided as dried citrus(e.g., orange) peel. In some embodiments, the CF is alternatively or additionally provided as dried citrus (e.g., orange) pulp.

In some embodiments, the CF is provided as citrus(e.g., orange) flour.

In some embodiments, the CF in the antioxidant is a dried CF (e.g., a power, granule, etc.). In some embodiments, the CF in the antioxidant is in the form of a suspension.

A variety of citrus fibers are commercially available. These include citrus fibers from, for example, Herbafood Ingredients GmbH (Werder, Germany) under the HERBACEL name; and Fiberstar, Inc. (River Falls, Wis., USA) under the CITRI-FI name.

In general, the amount of CF used in a process of this specification is an amount that provides a desired antioxidant effect, taking into account the amount of GTE used as well. In some embodiments, the amount of CF used is an amount that has a sufficient amount of polyphenols (particularly polyphenols that are water-insoluble) attached to the fibers to provide the desired antioxidant effect, taking into account the amount of the GTE used as well. In some embodiments, the amount of CF used in an amount that also does not negatively impact the desired flavor. In some embodiments, the amount of CF used is an amount that also imparts a pleasant or otherwise desired flavor.

In some embodiments, the antioxidant composition of this specification comprises the CF at a concentration of at least 10% (by weight), based on the total weight of the antioxidant composition. In some embodiments, the antioxidant composition comprises the CF at a concentration of at least 20% (by weight), based on the total weight of the antioxidant composition. In some embodiments, the antioxidant composition comprises the CF at a concentration of at least 30% (by weight), based on the total weight of the antioxidant composition. In some embodiments, the antioxidant composition comprises the CF at a concentration of at least 40% (by weight), based on the total weight of the antioxidant composition. In some embodiments, the antioxidant composition comprises the CF at a concentration of at least 50% (by weight), based on the total weight of the antioxidant composition. In some embodiments, the antioxidant composition comprises the CF at a concentration of at least 60% (by weight), based on the total weight of the antioxidant composition. In some embodiments, the antioxidant composition comprises the CF at a concentration of at least 70% (by weight), based on the total weight of the antioxidant composition. In some embodiments, the antioxidant composition comprises the CF at a concentration of at least 75% (by weight), based on the total weight of the antioxidant composition. In some embodiments, the antioxidant composition comprises the CF at a concentration of at least 80% (by weight), based on the total weight of the antioxidant composition. In some embodiments, the antioxidant composition comprises the CF at a concentration of at least 85% (by weight), based on the total weight of the antioxidant composition. In some embodiments, the antioxidant composition comprises the CF at a concentration of at least 90% (by weight), based on the total weight of the antioxidant composition. In some embodiments, the antioxidant composition comprises the CF at a concentration of at least 95% (by weight), based on the total weight of the antioxidant composition. In some embodiments, the antioxidant composition comprises the CF at a concentration of at least 99% (by weight), based on the total weight of the antioxidant composition.

In some embodiments, the antioxidant composition comprises the CF at a concentration of no greater than 99% (by weight), based on the total weight of the antioxidant composition. In some embodiments, the antioxidant composition comprises the CF at a concentration of no greater than 95% (by weight), based on the total weight of the antioxidant composition. In some embodiments, the antioxidant composition comprises the CF at a concentration of no greater than 90% (by weight), based on the total weight of the antioxidant composition. In some embodiments, the antioxidant composition comprises the CF at a concentration of no greater than 85% (by weight), based on the total weight of the antioxidant composition. In some embodiments, the antioxidant composition comprises the CF at a concentration of no greater than 80% (by weight), based on the total weight of the antioxidant composition. In some embodiments, the antioxidant composition comprises the CF at a concentration of no greater than 75% (by weight), based on the total weight of the antioxidant composition.

In some embodiments, the antioxidant composition comprises the CF at a concentration of from 40 to 99% (by weight), based on the total weight of the antioxidant composition. In some embodiments, the antioxidant composition comprises the CF at a concentration of from 40 to 95% (by weight), based on the total weight of the antioxidant composition. In some embodiments, the antioxidant composition comprises the CF at a concentration of from 40 to 90% (by weight), based on the total weight of the antioxidant composition. In some embodiments, the antioxidant composition comprises the CF at a concentration of from 40 to 85% (by weight), based on the total weight of the antioxidant composition. In some embodiments, the antioxidant composition comprises the CF at a concentration of from 40 to 80% (by weight), based on the total weight of the antioxidant composition. In some embodiments, the antioxidant composition comprises the CF at a concentration of from 40 to 75% (by weight), based on the total weight of the antioxidant composition.

In some embodiments, the antioxidant composition comprises the CF at a concentration of from 50 to 99% (by weight), based on the total weight of the antioxidant composition. In some embodiments, the antioxidant composition comprises the CF at a concentration of from 50 to 95% (by weight), based on the total weight of the antioxidant composition. In some embodiments, the antioxidant composition comprises the CF at a concentration of from 50 to 90% (by weight), based on the total weight of the antioxidant composition. In some embodiments, the antioxidant composition comprises the CF at a concentration of from 50 to 85% (by weight), based on the total weight of the antioxidant composition. In some embodiments, the antioxidant composition comprises the CF at a concentration of from 50 to 80% (by weight), based on the total weight of the antioxidant composition. In some embodiments, the antioxidant composition comprises the CF at a concentration of from 50 to 75% (by weight), based on the total weight of the antioxidant composition.

In some embodiments, the antioxidant composition comprises the CF at a concentration of from 60 to 99% (by weight), based on the total weight of the antioxidant composition. In some embodiments, the antioxidant composition comprises the CF at a concentration of from 60 to 95% (by weight), based on the total weight of the antioxidant composition. In some embodiments, the antioxidant composition comprises the CF at a concentration of from 60 to 90% (by weight), based on the total weight of the antioxidant composition. In some embodiments, the antioxidant composition comprises the CF at a concentration of from 60 to 85% (by weight), based on the total weight of the antioxidant composition. In some embodiments, the antioxidant composition comprises the CF at a concentration of from 60 to 80% (by weight), based on the total weight of the antioxidant composition. In some embodiments, the antioxidant composition comprises the CF at a concentration of from 60 to 75% (by weight), based on the total weight of the antioxidant composition.

In some embodiments, the antioxidant composition comprises the CF at a concentration of from 70 to 99% (by weight), based on the total weight of the antioxidant composition. In some embodiments, the antioxidant composition comprises the CF at a concentration of from 70 to 95% (by weight), based on the total weight of the antioxidant composition. In some embodiments, the antioxidant composition comprises the CF at a concentration of from 70 to 90% (by weight), based on the total weight of the antioxidant composition. In some embodiments, the antioxidant composition comprises the CF at a concentration of from 70 to 85% (by weight), based on the total weight of the antioxidant composition. In some embodiments, the antioxidant composition comprises the CF at a concentration of from 70 to 80% (by weight), based on the total weight of the antioxidant composition. In some embodiments, the antioxidant composition comprises the CF at a concentration of from 70 to 75% (by weight), based on the total weight of the antioxidant composition.

In some embodiments, the antioxidant composition comprises the CF at a concentration of from 80 to 99% (by weight), based on the total weight of the antioxidant composition. In some embodiments, the antioxidant composition comprises the CF at a concentration of from 80 to 95% (by weight), based on the total weight of the antioxidant composition. In some embodiments, the antioxidant composition comprises the CF at a concentration of from 80 to 90% (by weight), based on the total weight of the antioxidant composition. In some embodiments, the antioxidant composition comprises the CF at a concentration of from 80 to 85% (by weight), based on the total weight of the antioxidant composition.

### Antioxidant Composition

The composition used in a process of this specification comprises an antioxidant composition. In general, the amounts of GTE and CF present in the antioxidant composition are amounts that, together, provide a desired antioxidant effect. In some embodiments, such amounts also are amounts that, together, have little or no negative impact flavor. In some embodiments, the amounts are amounts that impart a pleasant or otherwise desired flavor.

In some embodiments, the GTE/CF weight ratio in the antioxidant composition is from 1:30 to 30:1.

In some embodiments, the GTE/CF weight ratio in the antioxidant compostion is from 1:25 to 10:1. In some embodiments, the GTE/CF weight ratio is from 1:15 to 1:1. In some embodiments, the GTE/CF weight ratio is from 1:15 to 1:3. In some embodiments, the GTE/CF weight ratio is from 1:15 to 1:4. In some embodiments, the GTE/CF weight ratio is from 1:15 to 1:5. In some embodiments, the GTE/CF weight ratio is from 1:15 to 1:7. In some embodiments, the GTE/CF weight ratio is from 1:12 to 1:3.In some embodiments, the GTE/CF weight ratio is from 1:12 to 1:4. In some embodiments, the GTE/CF weight ratio is from 1:12 to 1:5. In some embodiments, the GTE/CF weight ratio is from 1:12 to 1:7. In some embodiments, the GTE/CF weight ratio is from 1:10 to 1:7. In some embodiments, the GTE/CF weight ratio is from 1:10 to 1:8. In some embodiments, the GTE/CF weight ratio is about 1:9.

In some embodiments, the GTE/CF weight ratio in the antioxidant composition is from 1:10 to 25:1. In some embodiments, the GTE/CF weight ratio is from 1:10 to 15:1. In some embodiments, the GTE/CF weight ratio is from 1:5 to 15:1. In some embodiments, the GTE/CF weight ratio is from 1:1 to 15:1. In some embodiments, the GTE/CF weight ratio is from 2:1 to 15:1. In some embodiments, the GTE/CF weight ratio is from 3:1 to 15:1. In some embodiments, the GTE/CF weight ratio is from 5:1 to 15:1. In some embodiments, the GTE/CF weight ratio is from 7:1 to 15:1. In some embodiments, the GTE/CF weight ratio is from 1:1 to 12:1. In some embodiments, the GTE/CF weight ratio is from 2:1 to 12:1. In some embodiments, the GTE/CF weight ratio is from 3:1 to 12:1. In some embodiments, the GTE/CF weight ratio is from 5:1 to 12:1:. In some embodiments, the GTE/CF weight ratio is from 7:1 to 12:1. In some embodiments, the GTE/CF weight ratio is from 1:1 to 10:1. In some embodiments, the GTE/CF weight ratio is from 2:1 to 10:1. In some embodiments, the GTE/CF weight ratio is from 3:1 to 10:1. In some embodiments, the GTE/CF weight ratio is from 1:1 to 5:1. In some embodiments, the GTE/CF weight ratio is from 2:1 to 5:1. In some embodiments, the GTE/CF weight ratio is from 3:1 to 5:1. In some embodiments, the GTE/CF weight ratio is from 1:1 to 4:1. In some embodiments, the GTE/CF weight ratio is from 2:1 to 4:1.

In some embodiments, the antioxidant composition comprises both: (i) a GTE concentration falling within a GTE concentration range discussed in this specification, and (ii) a GTE/CF weight ratio falling within a GTE/CF weight ratio range discussed in this specification. In some embodiments, the antioxidant composition comprises both: (i) a CF concentration falling within a CF concentration range discussed in this specification, and (ii) a GTE/CF weight ratio falling within a GTE/CF weight ratio range discussed in this specification. In some embodiments, the antioxidant composition comprises all the following: (i) a GTE concentration falling within a GTE concentration range discussed in this specification, (ii) a CF concentration falling within a CF concentration range discussed in this specification, and (iii) a GTE/CF weight ratio falling within a GTE/CF weight ratio range discussed in this specification.

In some embodiments, the antioxidant composition comprises dried citrus (e.g., orange) peel. In some embodiments, the antioxidant composition alternatively or additionally comprises dried citrus (e.g., orange) pulp. In some embodiments, the antioxidant composition comprises citrus (e.g., orange) flour.

In some embodiments, the antioxidant composition is a flavorant composition suitable for addition to a foodstuff.

In some embodiments, the antioxidant composition is in the form of a dried solid. The antioxidation composition can, however, be in other forms), based on the weight of the foodstuff. In some embodiments, the antioxidant composition of this specification is dosed to a foodstuff in an amount to provide the CF in an amount of, for example, a suspension.

### Application

In some embodiments, an antioxidant composition is contacted with a foodstuff to reduce oxidation of the foodstuff. In some embodiments, the foodstuff comprises an emulsion. In some such embodiments, the emulsion comprises an oil-in-water emulsion. In other embodiments, the emulsion comprises a water-in-oil emulsion. In some embodiments, the emulsion comprises a double emulsion. A “double emulsion” is an emulsion in an emulsion. In some embodiments, the double emulsion is a water-in-oil-in-water emulsion. In some embodiments, the double emulsion is an oil-in-water-in-oil emulsion.

Many foodstuffs may be preserved by an antioxidant composition or process of this specification. Typical foodstuffs are raw meat, cooked meat, raw poultry products, cooked poultry products, raw seafood products, cooked seafood products, cereals, cereal bars, ready to eat meals, pasta sauces, pasteurised soups, mayonnaise, salad dressings, oil-in-water emulsions, margarines, low fat spreads, water-in-oil emulsions, dairy products, cheese spreads, processed cheese, dairy desserts, flavored milks, cream, fermented milk products, cheese, butter, condensed milk products, ice cream mixes, soy products, pasteurised liquid egg, bakery products, confectionery products, fruit products, and foods with fat-based or water-containing fillings.

In some embodiments, the foodstuff comprises a meat, cereal, cereal bar, pasta sauce, pasteurised soup, butter, margarine, low-fat spread, dairy product, soy products, pasteurised liquid egg, bakery product, confectionery product, fruit product, or food with a fat-based or water-containing filling.

In some embodiments, the foodstuff comprises a poultry meat product, seafood product, butter, cheese spread, processed cheese, dairy dessert, flavored milk, cream, fermented milk product, condensed milk product, ice cream mix.

In some embodiments, the foodstuff is mayonnaise, a salad dressing, an oil-in-water emulsion, a water-in-oil emulsion or a double emulsion. In some embodiments, the foodstuff is an oil-in-water emulsion. In some embodiments, the foodstuff is a water-in-oil emulsion. In some embodiments, the foodstuff is a water-in-oil-in-water emulsion. In some embodiments, the foodstuff is an oil-in-water-in-oil emulsion. In some embodiments, the foodstuff is mayonnaise. In some embodiments, the foodstuff is a salad dressing. In some embodiments, the foodstuff is a beverage.

In some embodiments, the foodstuff comprises an animal feed), based on the weight of the foodstuff. In some embodiments, the antioxidant composition of this specification is dosed to a foodstuff in an amount to provide the CF in an amount of a feed for a companion animal or livestock animal.

In some embodiments, the antioxidant is dosed to a foodstuff in an amount of no greater than 1% (by weight), based on the weight of the foodstuff. In some embodiments, the antioxidant is dosed to a foodstuff in an amount of no greater than 0.9% (by weight), based on the weight of the foodstuff. In some embodiments, the antioxidant is dosed to a foodstuff in an amount of no greater than 0.8% (by weight), based on the weight of the foodstuff. In some embodiments, the antioxidant is dosed to a foodstuff in an amount of no greater than 0.7% (by weight), based on the weight of the foodstuff. In some embodiments, the antioxidant is dosed to a foodstuff in an amount of no greater than 0.6% (by weight), based on the weight of the foodstuff. In some embodiments, the antioxidant is dosed to a foodstuff in an amount of no greater than 0.6% (by weight), based on the weight of the foodstuff. In some embodiments, the antioxidant is dosed to a foodstuff in an amount of no greater than 0.4% (by weight), based on the weight of the foodstuff. In some embodiments, the antioxidant is dosed to a foodstuff in an amount of no greater than 0.3% (by weight), based on the weight of the foodstuff. In some embodiments, the antioxidant is dosed to a foodstuff in an amount of no greater than 0.3% (by weight), based on the weight of the foodstuff. In some embodiments, the antioxidant is dosed to a foodstuff in an amount of no greater than 0.1% (by weight), based on the weight of the foodstuff. In some embodiments, the antioxidant is dosed to a foodstuff in an amount of no greater than 0.09% (by weight), based on the weight of the foodstuff. In some embodiments, the antioxidant is dosed to a foodstuff in an amount of no greater than 0.08% (by weight), based on the weight of the foodstuff. In some embodiments, the antioxidant is dosed to a foodstuff in an amount of no greater than 0.07% (by weight), based on the weight of the foodstuff. In some embodiments, the antioxidant is dosed to a foodstuff in an amount of no greater than 0.06% (by weight), based on the weight of the foodstuff. In some embodiments, the antioxidant is dosed to a foodstuff in an amount of no greater than 0.05% (by weight), based on the weight of the foodstuff. In some embodiments, the antioxidant is dosed to a foodstuff in an amount of no greater than 0.04% (by weight), based on the weight of the foodstuff. In some embodiments, the antioxidant is dosed to a foodstuff in an amount of no greater than 0.03% (by weight), based on the weight of the foodstuff. In some embodiments, the antioxidant is dosed to a foodstuff in an amount of no greater than 0.02% (by weight), based on the weight of the foodstuff. In some embodiments, the antioxidant is dosed to a foodstuff in an amount of no greater than 0.01% (by weight), based on the weight of the foodstuff.

In some embodiments, an antioxidant of this specification is dosed to a foodstuff in an amount of from 0.01 to 1% (by weight), based on the weight of the foodstuff. In some embodiments, an antioxidant of this specification is dosed to a foodstuff in an amount of from 0.01 to 0.9% (by weight), based on the weight of the foodstuff. In some embodiments, an antioxidant of this specification is dosed to a foodstuff in an amount of from 0.01 to 0.8% (by weight), based on the weight of the foodstuff. In some embodiments, an antioxidant of this specification is dosed to a foodstuff in an amount of from 0.01 to 0.7% (by weight), based on the weight of the foodstuff. In some embodiments, an antioxidant of this specification is dosed to a foodstuff in an amount of from 0.01 to 0.6% (by weight), based on the weight of the foodstuff. In some embodiments, an antioxidant of this specification is dosed to a foodstuff in an amount of from 0.01 to 0.5% (by weight), based on the weight of the foodstuff. In some embodiments, an antioxidant of this specification is dosed to a foodstuff in an amount of from 0.01 to 0.4% (by weight), based on the weight of the foodstuff. In some embodiments, an antioxidant of this specification is dosed to a foodstuff in an amount of from 0.01 to 0.3% (by weight), based on the weight of the foodstuff. In some embodiments, an antioxidant of this specification is dosed to a foodstuff in an amount of from 0.01 to 0.2% (by weight), based on the weight of the foodstuff. In some embodiments, an antioxidant of this specification is dosed to a foodstuff in an amount of from 0.01 to 0.1% (by weight), based on the weight of the foodstuff.

In some embodiments, an antioxidant of this specification is dosed to a foodstuff in an amount of from 0.02% (by weight) to 1% (by weight), based on the weight of the foodstuff. In some embodiments, an antioxidant of this specification is dosed to a foodstuff in an amount of from 0.02 to 0.9% (by weight), based on the weight of the foodstuff. In some embodiments, an antioxidant of this specification is dosed to a foodstuff in an amount of from 0.02 to 0.8% (by weight), based on the weight of the foodstuff. In some embodiments, an antioxidant of this specification is dosed to a foodstuff in an amount of from 0.02 to 0.7% (by weight), based on the weight of the foodstuff. In some embodiments, an antioxidant of this specification is dosed to a foodstuff in an amount of from 0.02 to 0.6% (by weight), based on the weight of the foodstuff. In some embodiments, an antioxidant of this specification is dosed to a foodstuff in an amount of from 0.02 to 0.5% (by weight), based on the weight of the foodstuff. In some embodiments, an antioxidant of this specification is dosed to a foodstuff in an amount of from 0.02 to 0.4% (by weight), based on the weight of the foodstuff. In some embodiments, an antioxidant of this specification is dosed to a foodstuff in an amount of from 0.02 to 0.3% (by weight), based on the weight of the foodstuff. In some embodiments, an antioxidant of this specification is dosed to a foodstuff in an amount of from 0.02 to 0.2% (by weight), based on the weight of the foodstuff. In some embodiments, an antioxidant of this specification is dosed to a foodstuff in an amount of from 0.02 to 0.1% (by weight), based on the weight of the foodstuff.

In some embodiments, an antioxidant of this specification is dosed to a foodstuff in an amount of from 0.03% (by weight) to 1% (by weight), based on the weight of the foodstuff. In some embodiments, an antioxidant of this specification is dosed to a foodstuff in an amount of from 0.03 to 0.9% (by weight), based on the weight of the foodstuff. In some embodiments, an antioxidant of this specification is dosed to a foodstuff in an amount of from 0.03 to 0.8% (by weight), based on the weight of the foodstuff. In some embodiments, an antioxidant of this specification is dosed to a foodstuff in an amount of from 0.03 to 0.7% (by weight), based on the weight of the foodstuff. In some embodiments, an antioxidant of this specification is dosed to a foodstuff in an amount of from 0.03 to 0.6% (by weight), based on the weight of the foodstuff. In some embodiments, an antioxidant of this specification is dosed to a foodstuff in an amount of from 0.03 to 0.5% (by weight), based on the weight of the foodstuff. In some embodiments, an antioxidant of this specification is dosed to a foodstuff in an amount of from 0.03 to 0.4% (by weight), based on the weight of the foodstuff. In some embodiments, an antioxidant of this specification is dosed to a foodstuff in an amount of from 0.03 to 0.3% (by weight), based on the weight of the foodstuff. In some embodiments, an antioxidant of this specification is dosed to a foodstuff in an amount of from 0.03 to 0.2% (by weight), based on the weight of the foodstuff. In some embodiments, an antioxidant of this specification is dosed to a foodstuff in an amount of from 0.03 to 0.1% (by weight), based on the weight of the foodstuff.

In some embodiments, an antioxidant of this specification is dosed to a foodstuff in an amount of from 0.04% (by weight) to 1% (by weight), based on the weight of the foodstuff. In some embodiments, an antioxidant of this specification is dosed to a foodstuff in an amount of from 0.04 to 0.9% (by weight), based on the weight of the foodstuff. In some embodiments, an antioxidant of this specification is dosed to a foodstuff in an amount of from 0.04 to 0.8% (by weight), based on the weight of the foodstuff. In some embodiments, an antioxidant of this specification is dosed to a foodstuff in an amount of from 0.04 to 0.7% (by weight), based on the weight of the foodstuff. In some embodiments, an antioxidant of this specification is dosed to a foodstuff in an amount of from 0.04 to 0.6% (by weight), based on the weight of the foodstuff. In some embodiments, an antioxidant of this specification is dosed to a foodstuff in an amount of from 0.04 to 0.5% (by weight), based on the weight of the foodstuff. In some embodiments, an antioxidant of this specification is dosed to a foodstuff in an amount of from 0.04 to 0.4% (by weight), based on the weight of the foodstuff. In some embodiments, an antioxidant of this specification is dosed to a foodstuff in an amount of from 0.04 to 0.3% (by weight), based on the weight of the foodstuff. In some embodiments, an antioxidant of this specification is dosed to a foodstuff in an amount of from 0.04 to 0.2% (by weight), based on the weight of the foodstuff. In some embodiments, an antioxidant of this specification is dosed to a foodstuff in an amount of from 0.04 to 0.1% (by weight), based on the weight of the foodstuff.

In some embodiments, an antioxidant of this specification is dosed to a foodstuff in an amount of from 0.05% (by weight) to 1% (by weight), based on the weight of the foodstuff. In some embodiments, an antioxidant of this specification is dosed to a foodstuff in an amount of from 0.05 to 0.9% (by weight), based on the weight of the foodstuff. In some embodiments, an antioxidant of this specification is dosed to a foodstuff in an amount of from 0.05 to 0.8% (by weight), based on the weight of the foodstuff. In some embodiments, an antioxidant of this specification is dosed to a foodstuff in an amount of from 0.05 to 0.7% (by weight), based on the weight of the foodstuff. In some embodiments, an antioxidant of this specification is dosed to a foodstuff in an amount of from 0.05 to 0.6% (by weight), based on the weight of the foodstuff. In some embodiments, an antioxidant of this specification is dosed to a foodstuff in an amount of from 0.05 to 0.5% (by weight), based on the weight of the foodstuff. In some embodiments, an antioxidant of this specification is dosed to a foodstuff in an amount of from 0.05 to 0.4% (by weight), based on the weight of the foodstuff. In some embodiments, an antioxidant of this specification is dosed to a foodstuff in an amount of from 0.05 to 0.3% (by weight), based on the weight of the foodstuff. In some embodiments, an antioxidant of this specification is dosed to a foodstuff in an amount of from 0.05 to 0.2% (by weight), based on the weight of the foodstuff. In some embodiments, an antioxidant of this specification is dosed to a foodstuff in an amount of from 0.05 to 0.1% (by weight), based on the weight of the foodstuff.

In some embodiments, an antioxidant of this specification is dosed to a foodstuff in an amount of from 0.06% (by weight) to 1% (by weight), based on the weight of the foodstuff. In some embodiments, an antioxidant of this specification is dosed to a foodstuff in an amount of from 0.06 to 0.9% (by weight), based on the weight of the foodstuff. In some embodiments, an antioxidant of this specification is dosed to a foodstuff in an amount of from 0.06 to 0.8% (by weight), based on the weight of the foodstuff. In some embodiments, an antioxidant of this specification is dosed to a foodstuff in an amount of from 0.06 to 0.7% (by weight), based on the weight of the foodstuff. In some embodiments, an antioxidant of this specification is dosed to a foodstuff in an amount of from 0.06 to 0.6% (by weight), based on the weight of the foodstuff. In some embodiments, an antioxidant of this specification is dosed to a foodstuff in an amount of from 0.06 to 0.5% (by weight), based on the weight of the foodstuff. In some embodiments, an antioxidant of this specification is dosed to a foodstuff in an amount of from 0.06 to 0.4% (by weight), based on the weight of the foodstuff. In some embodiments, an antioxidant of this specification is dosed to a foodstuff in an amount of from 0.06 to 0.3% (by weight), based on the weight of the foodstuff. In some embodiments, an antioxidant of this specification is dosed to a foodstuff in an amount of from 0.06 to 0.2% (by weight), based on the weight of the foodstuff. In some embodiments, an antioxidant of this specification is dosed to a foodstuff in an amount of from 0.06 to 0.1% (by weight), based on the weight of the foodstuff.

In some embodiments, an antioxidant of this specification is dosed to a foodstuff in an amount of from 0.07% (by weight) to 1% (by weight), based on the weight of the foodstuff. In some embodiments, an antioxidant of this specification is dosed to a foodstuff in an amount of from 0.07 to 0.9% (by weight), based on the weight of the foodstuff. In some embodiments, an antioxidant of this specification is dosed to a foodstuff in an amount of from 0.07 to 0.8% (by weight), based on the weight of the foodstuff. In some embodiments, an antioxidant of this specification is dosed to a foodstuff in an amount of from 0.07 to 0.7% (by weight), based on the weight of the foodstuff. In some embodiments, an antioxidant of this specification is dosed to a foodstuff in an amount of from 0.07 to 0.6% (by weight), based on the weight of the foodstuff. In some embodiments, an antioxidant of this specification is dosed to a foodstuff in an amount of from 0.07 to 0.5% (by weight), based on the weight of the foodstuff. In some embodiments, an antioxidant of this specification is dosed to a foodstuff in an amount of from 0.07 to 0.4% (by weight), based on the weight of the foodstuff. In some embodiments, an antioxidant of this specification is dosed to a foodstuff in an amount of from 0.07 to 0.3% (by weight), based on the weight of the foodstuff. In some embodiments, an antioxidant of this specification is dosed to a foodstuff in an amount of from 0.07 to 0.2% (by weight), based on the weight of the foodstuff. In some embodiments, an antioxidant of this specification is dosed to a foodstuff in an amount of from 0.07 to 0.1% (by weight), based on the weight of the foodstuff.

In some embodiments, an antioxidant of this specification is dosed to a foodstuff in an amount of from 0.08% (by weight) to 1% (by weight), based on the weight of the foodstuff. In some embodiments, an antioxidant of this specification is dosed to a foodstuff in an amount of from 0.08 to 0.9% (by weight), based on the weight of the foodstuff. In some embodiments, an antioxidant of this specification is dosed to a foodstuff in an amount of from 0.08 to 0.8% (by weight), based on the weight of the foodstuff. In some embodiments, an antioxidant of this specification is dosed to a foodstuff in an amount of from 0.08 to 0.7% (by weight), based on the weight of the foodstuff. In some embodiments, an antioxidant of this specification is dosed to a foodstuff in an amount of from 0.08 to 0.6% (by weight), based on the weight of the foodstuff. In some embodiments, an antioxidant of this specification is dosed to a foodstuff in an amount of from 0.08 to 0.5% (by weight), based on the weight of the foodstuff. In some embodiments, an antioxidant of this specification is dosed to a foodstuff in an amount of from 0.08 to 0.4% (by weight), based on the weight of the foodstuff. In some embodiments, an antioxidant of this specification is dosed to a foodstuff in an amount of from 0.08 to 0.3% (by weight), based on the weight of the foodstuff. In some embodiments, an antioxidant of this specification is dosed to a foodstuff in an amount of from 0.08 to 0.2% (by weight), based on the weight of the foodstuff. In some embodiments, an antioxidant of this specification is dosed to a foodstuff in an amount of from 0.08 to 0.1% (by weight), based on the weight of the foodstuff.

In some embodiments, an antioxidant of this specification is dosed to a foodstuff in an amount of from 0.09% (by weight) to 1% (by weight), based on the weight of the foodstuff. In some embodiments, an antioxidant of this specification is dosed to a foodstuff in an amount of from 0.09 to 0.9% (by weight), based on the weight of the foodstuff. In some embodiments, an antioxidant of this specification is dosed to a foodstuff in an amount of from 0.09 to 0.8% (by weight), based on the weight of the foodstuff. In some embodiments, an antioxidant of this specification is dosed to a foodstuff in an amount of from 0.09 to 0.7% (by weight), based on the weight of the foodstuff. In some embodiments, an antioxidant of this specification is dosed to a foodstuff in an amount of from 0.09 to 0.6% (by weight), based on the weight of the foodstuff. In some embodiments, an antioxidant of this specification is dosed to a foodstuff in an amount of from 0.09 to 0.5% (by weight), based on the weight of the foodstuff. In some embodiments, an antioxidant of this specification is dosed to a foodstuff in an amount of from 0.09 to 0.4% (by weight), based on the weight of the foodstuff. In some embodiments, an antioxidant of this specification is dosed to a foodstuff in an amount of from 0.09 to 0.3% (by weight), based on the weight of the foodstuff. In some embodiments, an antioxidant of this specification is dosed to a foodstuff in an amount of from 0.09 to 0.2% (by weight), based on the weight of the foodstuff. In some embodiments, an antioxidant of this specification is dosed to a foodstuff in an amount of from 0.09 to 0.1% (by weight), based on the weight of the foodstuff.

In some embodiments, the antioxidant composition of this specification is dosed to a foodstuff in an amount to provide the GTE in an amount of no greater than 0.5% (by weight), based on the weight of the foodstuff. In some embodiments, the antioxidant composition of this specification is dosed to a foodstuff in an amount to provide the GTE in an amount of no greater than 0.4% (by weight), based on the weight of the foodstuff. In some embodiments, the antioxidant composition of this specification is dosed to a foodstuff in an amount to provide the GTE in an amount of no greater than 0.3% (by weight), based on the weight of the foodstuff. In some embodiments, the antioxidant composition of this specification is dosed to a foodstuff in an amount to provide the GTE in an amount of no greater than 0.2% (by weight), based on the weight of the foodstuff. In some embodiments, the antioxidant composition of this specification is dosed to a foodstuff in an amount to provide the GTE in an amount of no greater than 0.1% (by weight), based on the weight of the foodstuff. In some embodiments, the antioxidant composition of this specification is dosed to a foodstuff in an amount to provide the GTE in an amount of no greater than 0.07% (by weight), based on the weight of the foodstuff. In some embodiments, the antioxidant composition of this specification is dosed to a foodstuff in an amount to provide the GTE in an amount of no greater than 0.05% (by weight), based on the weight of the foodstuff. In some embodiments, the antioxidant composition of this specification is dosed to a foodstuff in an amount to provide the GTE in an amount of no greater than 0.04% (by weight), based on the weight of the foodstuff. In some embodiments, the antioxidant composition of this specification is dosed to a foodstuff in an amount to provide the GTE in an amount of no greater than 0.03% (by weight), based on the weight of the foodstuff. In some embodiments, the antioxidant composition of this specification is dosed to a foodstuff in an amount to provide the GTE in an amount of no greater than 0.02% (by weight), based on the weight of the foodstuff. In some embodiments, the antioxidant composition of this specification is dosed to a foodstuff in an amount to provide the GTE in an amount of no greater than 0.025% (by weight), based on the weight of the foodstuff. In some embodiments, the antioxidant composition of this specification is dosed to a foodstuff in an amount to provide the GTE in an amount of no greater than 0.015% (by weight), based on the weight of the foodstuff. In some embodiments, the antioxidant composition of this specification is dosed to a foodstuff in an amount to provide the GTE in an amount of no greater than 0.01% (by weight), based on the weight of the foodstuff. In some embodiments, the antioxidant composition of this specification is dosed to a foodstuff in an amount to provide the GTE in an amount of no greater than 0.0075% (by weight), based on the weight of the foodstuff. In some embodiments, the antioxidant composition of this specification is dosed to a foodstuff in an amount to provide the GTE in an amount of no greater than 0.005% (by weight), based on the weight of the foodstuff.

In some embodiments, the antioxidant composition of this specification is dosed to a foodstuff in an amount to provide the GTE in an amount of from 0.5 to 1% (by weight), based on the weight of the foodstuff. In some embodiments, the antioxidant composition of this specification is dosed to a foodstuff in an amount to provide the GTE in an amount of from 0.4 to 1% (by weight), based on the weight of the foodstuff. In some embodiments, the antioxidant composition of this specification is dosed to a foodstuff in an amount to provide the GTE in an amount of from 0.3 to 1% (by weight), based on the weight of the foodstuff. In some embodiments, the antioxidant composition of this specification is dosed to a foodstuff in an amount to provide the GTE in an amount of from 0.2 to 1% (by weight), based on the weight of the foodstuff. In some embodiments, the antioxidant composition of this specification is dosed to a foodstuff in an amount to provide the GTE in an amount of from 0.01 to 1% (by weight), based on the weight of the foodstuff. In some embodiments, the antioxidant composition of this specification is dosed to a foodstuff in an amount to provide the GTE in an amount of from 0.07 to 1% (by weight), based on the weight of the foodstuff. In some embodiments, the antioxidant composition of this specification is dosed to a foodstuff in an amount to provide the GTE in an amount of from 0.05 to 1% (by weight), based on the weight of the foodstuff. In some embodiments, the antioxidant composition of this specification is dosed to a foodstuff in an amount to provide the GTE in an amount of from 0.04 to 1% (by weight), based on the weight of the foodstuff. In some embodiments, the antioxidant composition of this specification is dosed to a foodstuff in an amount to provide the GTE in an amount of from 0.03 to 1% (by weight), based on the weight of the foodstuff. In some embodiments, the antioxidant composition of this specification is dosed to a foodstuff in an amount to provide the GTE in an amount of from 0.02 to 1% (by weight), based on the weight of the foodstuff. In some embodiments, the antioxidant composition of this specification is dosed to a foodstuff in an amount to provide the GTE in an amount of from 0.01 to 1% (by weight), based on the weight of the foodstuff. In some embodiments, the antioxidant composition of this specification is dosed to a foodstuff in an amount to provide the GTE in an amount of from 0.005 to 1% (by weight), based on the weight of the foodstuff. In some embodiments, the antioxidant composition of this specification is dosed to a foodstuff in an amount to provide the GTE in an amount of from 0.005 to 0.05% (by weight), based on the weight of the foodstuff.

In some embodiments, the antioxidant composition of this specification is dosed to a foodstuff in an amount to provide the CF in an amount of no greater than 1% (by weight), based on the weight of the foodstuff. In some embodiments, the antioxidant composition of this specification is dosed to a foodstuff in an amount to provide the CF in an amount of no greater than 0.8% (by weight), based on the weight of the foodstuff. In some embodiments, the antioxidant composition of this specification is dosed to a foodstuff in an amount to provide the CF in an amount of no greater than 0.6% (by weight), based on the weight of the foodstuff. In some embodiments, the antioxidant composition of this specification is dosed to a foodstuff in an amount to provide the CF in an amount of no greater than 0.4% (by weight), based on the weight of the foodstuff. In some embodiments, the antioxidant composition of this specification is dosed to a foodstuff in an amount to provide the CF in an amount of no greater than 0.2% (by weight), based on the weight of the foodstuff. In some embodiments, the antioxidant composition of this specification is dosed to a foodstuff in an amount to provide the CF in an amount of no greater than 0.08% (by weight), based on the weight of the foodstuff. In some embodiments, the antioxidant composition of this specification is dosed to a foodstuff in an amount to provide the CF in an amount of no greater than 0.05% (by weight), based on the weight of the foodstuff. In some embodiments, the antioxidant composition of this specification is dosed to a foodstuff in an amount to provide the CF in an amount of no greater than 0.04% (by weight), based on the weight of the foodstuff. In some embodiments, the antioxidant composition of this specification is dosed to a foodstuff in an amount to provide the CF in an amount of no greater than 0.03% (by weight), based on the weight of the foodstuff. In some embodiments, the antioxidant composition of this specification is dosed to a foodstuff in an amount to provide the CF in an amount of no greater than 0.02% (by weight), based on the weight of the foodstuff. In some embodiments, the antioxidant composition of this specification is dosed to a foodstuff in an amount to provide the CF in an amount of no greater than 0.025% (by weight), based on the weight of the foodstuff. In some embodiments, the antioxidant composition of this specification is dosed to a foodstuff in an amount to provide the CF in an amount of no greater than 0.015% (by weight), based on the weight of the foodstuff. In some embodiments, the antioxidant composition of this specification is dosed to a foodstuff in an amount to provide the CF in an amount of no greater than 0.01% (by weight), based on the weight of the foodstuff. In some embodiments, the antioxidant composition of this specification is dosed to a foodstuff in an amount to provide the CF in an amount of no greater than 0.0075% (by weight), based on the weight of the foodstuff.

In some embodiments, the antioxidant composition of this specification is dosed to a foodstuff in an amount to provide the CF in an amount of from 0.005 to 1% (by weight), based on the weight of the foodstuff. In some embodiments, the antioxidant composition of this specification is dosed to a foodstuff in an amount to provide the CF in an amount of from 0.5 to 1% (by weight), based on the weight of the foodstuff. In some embodiments, the antioxidant composition of this specification is dosed to a foodstuff in an amount to provide the CF in an amount of from 0.4 to 1% (by weight), based on the weight of the foodstuff. In some embodiments, the antioxidant composition of this specification is dosed to a foodstuff in an amount to provide the CF in an amount of from 0.3 to 1% (by weight), based on the weight of the foodstuff. In some embodiments, the antioxidant composition of this specification is dosed to a foodstuff in an amount to provide the CF in an amount of from 0.2 to 1% (by weight), based on the weight of the foodstuff. In some embodiments, the antioxidant composition of this specification is dosed to a foodstuff in an amount to provide the CF in an amount of from 0.1 to 1% (by weight), based on the weight of the foodstuff. In some embodiments, the antioxidant composition of this specification is dosed to a foodstuff in an amount to provide the CF in an amount of from 0.07 to 1% (by weight), based on the weight of the foodstuff. In some embodiments, the antioxidant composition of this specification is dosed to a foodstuff in an amount to provide the CF in an amount of from 0.05 to 1% (by weight), based on the weight of the foodstuff. In some embodiments, the antioxidant composition of this specification is dosed to a foodstuff in an amount to provide the CF in an amount of from 0.04 to 1% (by weight), based on the weight of the foodstuff. In some embodiments, the antioxidant composition of this specification is dosed to a foodstuff in an amount to provide the CF in an amount of from 0.03 to 1% (by weight), based on the weight of the foodstuff. In some embodiments, the antioxidant composition of this specification is dosed to a foodstuff in an amount to provide the CF in an amount of from 0.02 to 1% (by weight), based on the weight of the foodstuff.

### Additional Components

In some embodiments, the antioxidation composition of this specification consists of the GTE and CF.

In other embodiments, the antioxidant composition of this specification comprises one or more additional components.

In some embodiments, the antioxidant composition of this specification comprises no components other than the GTE and CF that materially affect the antioxidative properties of antioxidant composition.

In some embodiments, the antioxidant composition comprises one or more carriers. In some embodiments, the carrier(s) is selected from propylene glycol, maltodextrin, sugar, salt, ethanol, water, protein, glycerol, medium chain triglyceride (MCT oil) and vegetable oil. In such embodiments, the GTE and CF may be blended with the carrier (or carriers) in a suitable manner. For example, the GTE and CF may be simply mixed with a suitable carrier (or carriers).

In some embodiments, the antioxidant composition comprises a carrier(s) at a total concentration of from 1 to 40% (by weight), based on the total weight of the antioxidant composition. In some embodiments, the antioxidant composition comprises a carrier(s) at a total concentration of from 2 to 35% (by weight), based on the total weight of the antioxidant composition. In some embodiments, the antioxidant composition comprises a carrier(s) at a total concentration of from 5 to 30% (by weight), based on the total weight of the antioxidant composition. In some embodiments, the antioxidant composition comprises a carrier(s) at a total concentration of from 5 to 25% (by weight), based on the total weight of the antioxidant composition. In some embodiments, the antioxidant composition comprises a carrier(s) at a total concentration of from 10 to 30% (by weight), based on the total weight of the antioxidant composition. In some embodiments, the antioxidant composition comprises a carrier(s) at a total concentration of from 10 to 25% (by weight), based on the total weight of the antioxidant composition. In some embodiments, the antioxidant composition comprises a carrier(s) at a total concentration of from 15 to 25% (by weight), based on the total weight of the antioxidant composition.

In some embodiments, the antioxidant composition comprises an emulsifier. In some such embodiments, the emulsifier is selected from polyoxyethylene sorbitan esters (polysorbates), polyoxyethylene stearate, mono- and diglycerides of fatty acids, mono- and diglycerides esters further esterified with a dibasic organic acid selected from acetic acid, lactic acid, citric acid and mono- and diacetyl tartaric acid or mixtures thereof, lecithin, polyglycerol esters of fatty acids, polyglycerol polyricinoleate, sucrose esters of fatty acids, sucroglycerides, propylene glycol esters of fatty acids, sorbitan esters of fatty acids, sodium and calcium salt of stearoyl-2-lactylate, sodium, potassium, calcium and magnesium salts of fatty acids and ammonium phosphatides.

### Use of Separate Compositions

Typically, the process discussed herein is more easily practiced by applying a single antioxidant composition comprising both the GTE and CF to a foodstuff to reduce oxidation. However, the process may alternatively be practiced by applying the GTE and CF as separate compositions to a foodstuff to reduce oxidation of the foodstuff.

In some such embodiments, the separate compositions are applied to the foodstuff at the same time. In other such embodiments, the separate compositions are alternatively or additionally applied separately to the foodstuff. Typically, any such separate applications are in close time proximity to each other.

In some embodiments, two separate compositions are applied to the foodstuff, wherein at least one of the two compositions comprises GTE and at least the other composition comprises CF. In some embodiments, two separate compositions are applied to the foodstuff, wherein only one of the compositions comprises GTE and only the other composition comprises CF.

In some embodiments, at least one of the separate compositions is a dry composition. In some embodiments, each of the separate compositions is a dry composition. In some embodiments, at least one of the separate compositions is a suspension. In some embodiments, each of the separate compositions is a suspension. In some embodiments, one of the separate compositions (e.g., the composition comprising GTE) is a liquid.

In general, the GTE and CF dosages and weight ratios discussed above for single antioxidation composition applications are equally applicable when the GTE and CF are applied to a foodstuff as separate compositions.

In some embodiments, the separate compositions are marketed as a kit comprising the separate compositions and instructions for their use to reduce the oxidation of a foodstuff.

### EXAMPLES

The following examples are merely illustrative, and not limiting to this specification in any way.

### Example 1

### Antioxidant Efficacy Evaluation

### Materials Used

Ethylenediaminetetraacetic acid (“EDTA”): A chemical metal chelator used in various food applications for oxidation control.

GUARDIAN™ CHELOX L (DuPont, New Century, Kans.): A commercially available antioxidant product comprising a blend of rosemary extract and chamomile extract.

Green tea extract: Obtained by a sequential solvent extraction process with hot water (at approximately 80° C.) and then ethyl acetate (at room temperature) from green tea leaves (Camellia sinensis), followed by spray drying. This extract contained approximately 80% (by weight) catechins.

Citrus fiber: CITRI-FI 100M40 (>95% (±4%) passing through 200 mesh) (Fiberstar, Inc., River Falls, Wis.). A natural fiber extracted from orange pulp.

### Methods

Use of a mixture of green tea [Camellia sinensis] extract (“GTE”) and citrus fiber (“CF”) was studied in mayonnaise. In this experiment, the GTE/CF blend was compared to a chemical antioxidant benchmark (EDTA) and a plant extract antioxidant benchmark (GUARDIAN™ CHELOX L).

The mayonnaise was produced according to the formulation in Table 1 and the procedure outlined below. All ingredients in the mayonnaise were food-grade quality. The antioxidant dosage was based on the total product mayonnaise weight. Specifically, the dosage of EDTA was 75 ppm (recommended and maximum allowed level by regulation); the dosage of GUARDIAN™ CHELOX L was 750 ppm (recommended level by the manufacturer, DuPont); and the dosage of the GTE/CF blend (10/90 blending ratio) was 1500 ppm.

TABLE 1
Mayonnaise formulation (%)

| | Mayonnaise | | | |
|---|---|---|---|---|
| | with no | | Mayonnaise with | |
| | antioxidants | Mayonnaise | GUARDIAN ™ | Mayonnaise |
| Ingredient | (control) | with EDTA | CHELOX L | with GTE + CF |
| Soybean Oil | 70 | 70 | 70 | 70 |
| Salt | 1 | 1 | 1 | 1 |
| Sucrose | 1.6 | 1.6 | 1.6 | 1.6 |
| Vinegar | 4 | 4 | 4 | 4 |
| Mustard powder | 0.25 | 0.25 | 0.25 | 0.25 |
| Egg yolk powder | 3 | 3 | 3 | 3 |
| EDTA | — | 0.0075 | — | — |
| Guardian ® Chelox L | — | — | 0.075 | — |
| GTE/CF* | — | — | — | 0.15 |
| Water | 20.15 | 20.1425 | 20.075 | 20 |
| TOTAL | 100 | 100 | 100 | 100 |

### Procedure

Water was added to a THERMOMIX™ TM5 blender (Vorwerk, Thousand Oaks, Calif.) with a butterfly attachment, followed by addition of sugar and the antioxidant. The contents were mixed at speed 2 for 2 min. The remaining ingredients, except the soybean oil and acids, were added and mixed for 1 min at speed 3. The soybean oil was then added slowly and mixed at speed 3.5 for 1.5 min, followed by addition of vinegar. The contents were emulsified under high shear at speed 6 for 2 min, and pH was adjusted to 3.8-4.0 with lactic acid.

The tested mayonnaise samples were stored at 37° C. The concentrations of peroxide and MDA were measured for each of the different formulations after 1, 2 and 4 weeks. These experiments were conducted in duplicate.

### Determination of Peroxide Value

Peroxide value was determined by ferric thiocyanate method according to IDF (International Dairy Federation) Standards 74A: 1991 with modifications. Briefly, 1.5 ml of isooctane/isopropanol (3/2) was added to 0.3 g of mayonnaise sample and the content mixed by shaking and vortexing. The mixture was then centrifuged at 3500 ppm for 5 min, and an aliquot (0.2 ml) of the supernatant was transferred to another tube, to which 2.8 ml of methanol/butanol (2/1) and 30 μl of Fe²⁺/thiocyanate reagent were added. The absorbance of the mixture was measured after exactly 20 min at 510 nm. Fe²⁺/thiocyanate reagent was prepared by mixing equal volumes of ammonium thiocyanate (3.94M) and Fe²⁺ solution (freshly prepared by mixing 0.132M barium chloride and 0.144M ferrous sulfate at 1:1 followed by centrifugation). Peroxide value was calculated from a standard curve of cumene hydroperoxide.

### Determination of MDA Value by TBARS Assay

Secondary oxidation products (TBARS as MDA equivalent) were measured by a spectrophotometric method on the mayonnaise samples. Briefly, 1 g of the mayonnaise sample was added to a centrifuge tube containing 5 ml of TCA (trichloroacetic acid, 10%, w/v) and 5 ml of TBA reagent (0.02M, prepared by stirring under very low heat) and the content was mixed by vortexing for 1 min. The tube was centrifuged at 9000 rpm for 5 min, and supernatant decanted to another clean tube. The tube was heated in a water bath at 95° C. for 45 min and then cooled down in an ice bath. The absorbance of the clear solution was measured at 532 nm, and results were calculated from a standard curve of tetraethoxypropane.

### Results

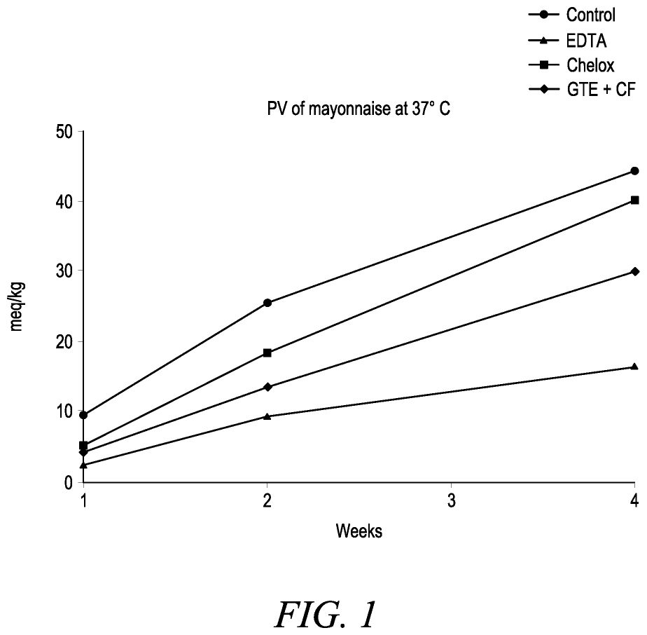

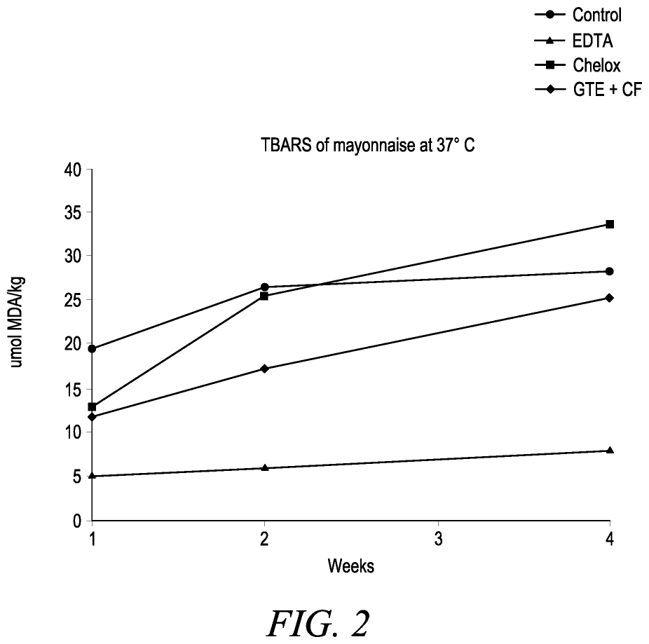

The average values of peroxide (measured as meq/kg of mayonnaise) and MDA (measured as μmol MDA eq./kg of mayonnaise) are shown in Table 2 and Table 3 below, and graphically in FIG. 1 and FIG. 2.

TABLE 2
Peroxide values (meq/kg) of mayonnaise after 1, 2 and
4 weeks of storage at 37° C.

| | 1 week | 2 weeks | 4 weeks |
|---|---|---|---|
| Control | 9.40 | 25.47 | 44.33 |
| EDTA | 2.40 | 9.27 | 16.33 |
| Chelox | 5.23 | 18.26 | 40.09 |
| GTE + CF | 4.23 | 13.47 | 29.98 |

TABLE 3
TBARS values (μ mol MDA eq./Kg) of mayonnaise
after 1, 2 and 4 weeks of storage at 37° C.

| | 1 week | 2 weeks | 4 weeks |
|---|---|---|---|
| Control | 19.47 | 26.51 | 28.35 |
| EDTA | 5.17 | 5.99 | 7.86 |
| Chelox | 12.99 | 25.53 | 33.61 |
| GTE + CF | 11.85 | 17.27 | 25.34 |

As can be seen, the control (without antioxidant) exhibited the highest degree of oxidation throughout the accelerated storage, as indicated by PV and TABRS. Addition of EDTA, Chelox and GTE/CF effectively reduced oxidation to various extents. While EDTA showed the strongest antioxidant efficacy, the GTE/CF blend was more effective than the GUARDIAN™ CHELOX L in reducing oxidation.

### Example 2

### Sensory Evaluation

A two-component mixture of green tea [Camellia sinensis] extract (“GTE”) and citrus fiber (“CF”) was investigated in mayonnaise for flavor contribution.

The mayonnaise was produced according to the formulation in Table 4 and the procedure outlined below. All ingredients in the mayonnaise were food-grade quality. The dosage was based on the total product mayonnaise weight. The dosages of GTE/CF blend (10/90 blending ratio) were 1500 ppm (low) and 3000 ppm (high).

TABLE 4
Mayonnaise formulation (%)

| Ingredients (%) | Control | Low | High |
|---|---|---|---|
| Soybean Oil | 70 | 70 | 70 |
| Salt | 1 | 1 | 1 |
| Sucrose | 1.6 | 1.6 | 1.6 |
| GTE/CF | — | 0.15 | 0.3 |
| Vinegar 50 grain | 4 | 4 | 4 |
| Mustard powder | 0.25 | 0.25 | 0.25 |
| Egg Yolk Powder | 3 | 3 | 3 |
| Water | 20.15 | 20 | 19.85 |
| TOTAL | 100 | 100 | 100 |

### Procedure

Water was added to a THERMOMIX™ TM5 blender with a butterfly attachment, followed by addition of sugar and the antioxidant. The contents were mixed at speed 2 for 2 min. The remaining ingredients, except oil and acids, were added and mixed for 1 min at speed 3. Oil was then added slowly and mixed at speed 3.5 for 1.5 min, followed by addition of vinegar. The contents were emulsified under high shear at speed 6 for 2 min, and pH was adjusted to 3.8-4.0 with lactic acid.

### Results

The freshly prepared mayonnaise samples were allowed to set in a cooler for 1 day before they were tasted by 6 untrained panelists. The flavors of mayonnaise containing a low (1500 ppm) and a high (3000 ppm) level of GTE/CF were evaluated and compared with that of the control base formula with no GTE/CF added. Four out of six panelists detected the flavor difference between the control and the samples containing GTE/CF at both levels. One panelist ranked the one with 1500 ppm of GTE/CF the most-liked flavor, one panelist reported sharp tartness with GTE/CF at both levels, one panelist described a stronger flavor with the GTE/CF containing samples, and one panelist described the GTE/CF samples different from control.

The words “comprise”, “comprises” and “comprising” are to be interpreted inclusively rather than exclusively. This interpretation is intended to be the same as the interpretation that these words are given under United States patent law at the time of this filing.

The singular forms “a” and “an” are intended to include plural referents unless the context dictates otherwise. Thus, for example, a reference to the presence of “an excipient” does not exclude the presence of multiple excipients unless the context dictates otherwise.

1. A process for reducing oxidation of a foodstuff, wherein the process comprises contacting the foodstuff with:
a green tea [Camellia sinensis] extract, and
a citrus fiber.

2. A process according to claim 1, wherein the process comprises contacting the foodstuff with an antioxidant composition comprising:
a green tea [Camellia sinensis] extract, and
a citrus fiber.

3-4. (canceled)

5. A process according to claim 1, wherein the citrus fiber is a dried citrus fiber.

6. A process according to claim 1, wherein the citrus fiber comprises citrus fiber from a peel of a citrus fruit.

7. A process according to claim 1, wherein the citrus fiber comprises citrus fiber from a tangerine, lemon, lime or grapefruit.

8. A process according to claim 1, wherein the citrus fiber comprises citrus fiber from an orange.

9. (canceled)

10. A process according to claim 1, wherein the foodstuff comprises a meat, cereal, cereal bar, pasta sauce, pasteurised soup, butter, margarine, low-fat spread, dairy product, soy products, pasteurised liquid egg, bakery product, confectionery product, fruit product, or food with a fat-based or water-containing filling.

11. (canceled)

12. A process according to claim 1, wherein the foodstuff comprises mayonnaise.

13. A process according to claim 1, wherein the foodstuff comprises an emulsion.

14. A process according to claim 13, wherein the emulsion is an oil-in water emulsion.

15. A process according to claim 13, wherein the emulsion is an water-in-oil emulsion.

16. A process according to claim 13, wherein the emulsion is a double emulsion.

17. A process according to claim 1, wherein the foodstuff comprises a salad dressing.

18. A process according to claim 2, wherein the antioxidant composition further comprises maltodextrin.

19-20. (canceled)

21. A process according to claim 2, wherein the green tea [Camellia sinensis] extract is present in the antioxidant composition at a concentration of at least 10% (by weight), based on the total weight of the antioxidant composition.

23-24. (canceled)

24. A process according to claim 2, wherein the citrus fiber is present in the antioxidant composition at a concentration of at least 80% (by weight), based on the total weight of the antioxidant composition.

25. A process according to claim 2, wherein the citrus fiber is present in the antioxidant composition at a concentration of from 50 to 95% (by weight), based on the total weight of the antioxidant composition.

26. A process according to claim 2, wherein the weight ratio of the antioxidant composition to the foodstuff is from 0.0001 to 0.01.

27-36. (canceled)

37. A preserved foodstuff composition, wherein:
the preserved foodstuff composition comprises:
a foodstuff, and
an antoxidant composition composition; and
the antioxidant composition comprises:
a green tea [Camellia sinensis] extract, and
a citrus fiber.

46. A kit, wherein the kit comprises:
a green tea [Camellia sinensis] extract,
a citrus fiber, and
instructions for contacting the green tea [Camellia sinensis] extract with a foodstuff to reduce oxidation of the foodstuff.
